(19) United States
(12) Patent Application Publication
(10) Pub. No.: US 2016/0300249 A1
(43) Pub. Date: Oct. 13, 2016

(54) SALES DATA PROCESSING APPARATUS AND METHOD FOR INPUTTING ATTRIBUTE INFORMATION

(71) Applicant: TOSHIBA TEC KABUSHIKI KAISHA, Tokyo (JP)

(72) Inventor: Takahiro Saitou, Izunokuni (JP)

(21) Appl. No.: 15/091,660

(22) Filed: Apr. 6, 2016

(30) Foreign Application Priority Data
Apr. 7, 2015 (JP) 2015-078629

(51) Int. Cl. G06Q 30/02; G06K 9/00; G06F 17/30

(52) U.S. Cl. CPC G06Q 30/0201; G06F 17/30259; G06K 9/00255; G06K 9/00275; G06K 9/00295

(57) ABSTRACT

The sales data processing apparatus comprises a sales object information storage module which stores sales object information of a sales object to which a transaction processing is carried out in a storage section; a first attribute storage module which associates attribute information indicating attributes determined based on face image information of a detected face with the sales object information and stores them in the storage section if a face through which attributes of a customer who purchases the sales object can be determined can be detected based on an image captured by a camera; a notification module which notifies an operator of a message for urging the operator to input the attribute information indicating attributes of the customer through an operation of the operator if the face through which attributes of the customer purchasing the sales object can be determined cannot be detected based on the captured image; an attribute input module which inputs the attribute information indicating attributes of the customer through an operation of the operator; and a second attribute storage module which associates attribute information input by the attribute input module with the sales object information and stores them in the storage section.

### CROSS-REFERENCE TO RELATED APPLICATION

This application is based upon and claims the benefit of priority from Japanese Patent Application No. 2015-078629, filed Apr. 7, 2015, the entire contents of which are incorporated herein by reference.

### FIELD

Embodiments described herein relate generally to a sales data processing apparatus and a method for inputting attribute information of a customer.

### BACKGROUND

In a store such as a convenience store, in order to execute a clientele analysis or a sales analysis of commodities, there is a case in which attribute information such as gender, age bracket and the like of a customer who purchases a commodity is acquired. The attribute information is acquired by analyzing an image of the customer captured by a camera arranged on a POS (Point of Sales) terminal and then inputting the attribute information of the customer automatically.

Incidentally, in order to input the attribute information according to the image of the customer, it is necessary to capture a face of the customer from the front side of the customer. However, it is possible that the attribute information of the customer cannot be input in a case in which the customer does not face the camera directly or in a case in which the customer wears a mask or a hat even if facing the camera directly.

### BRIEF DESCRIPTION OF DRAWINGS

FIG. 1 is a plane schematic view illustrating a state in which a POS terminal is arranged inside a store when viewed from the upper side according to an embodiment;

FIG. 2 is a perspective view illustrating the appearance of the POS terminal obtained by observing the POS terminal from an operator side according to the embodiment;

FIG. 3 is a perspective view illustrating the appearance of the POS terminal obtained by observing the POS terminal from a customer side according to the embodiment;

FIG. 4 is a plane view illustrating a part of an operation section of the POS terminal;

FIG. 5 is a block diagram illustrating a hardware structure of the POS terminal;

FIG. 6 is a memory map illustrating an example of a face master file of the POS terminal;

FIG. 7 is a functional block diagram illustrating functional components of the POS terminal; and

FIG. 8 is a flowchart illustrating procedures of a control processing of the POS terminal.

### DETAILED DESCRIPTION

In accordance with an embodiment, a sales data processing apparatus comprises a sales object information storage module configured to store sales object information of a sales object to which a transaction processing is carried out in a storage section, a first attribute storage module configured to associate attribute information indicating attributes determined based on face image information of a detected face with the sales object information and store them in the storage section in a case in which the face through with attributes of a customer who purchases the sales object can be determined can be detected based on an image captured by a camera, a notification module configured to notify an operator of a message for urging the operator to input the attribute information indicating attributes of the customer through an operation of the operator in a case in which the face through which attributes of the customer who purchases the sales object can be determined cannot be detected based on the captured image, an attribute input module configured to input the attribute information indicating attributes of the customer through an operation of the operator, and a second attribute storage module configured to associate attribute information input by the attribute input module with the sales object information and store them in the storage section.

In accordance with the embodiment, a method for controlling the sales data processing apparatus through a computer enables the computer to function as a sales object information storage module configured to store sales object information of a sales object, to which a transaction processing is carried out in a storage section, a first attribute storage module configured to associate attribute information indicating attributes determined based on face image information of the detected face with the sales object information and store them in the storage section in a case in which the face through which attributes of a customer who purchases the sales object can be determined can be detected based on an image captured by a camera, a notification module configured to notify an operator of a message for urging the operator to input the attribute information indicating attributes of the customer through an operation of the operator in a case in which the face through which attributes of the customer who purchases the sales object can be determined cannot be detected based on the captured image, an attribute input module configured to input the attribute information indicating attributes of the customer through an operation of the operator, and a second attribute storage module configured to associate attribute information input by the attribute input module with the sales object information and store them in the storage section.

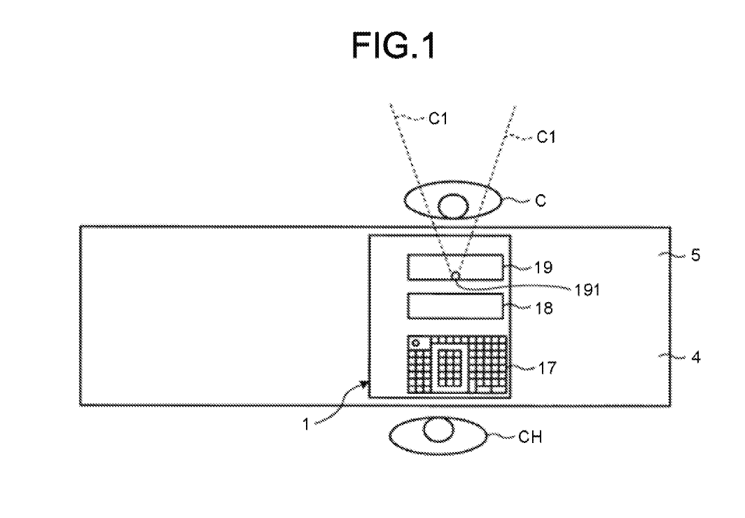

Hereinafter, with reference to FIG. 1-FIG. 8, the sales data processing apparatus and the method for inputting attribute information of a customer according to the embodiment are described in detail. In the embodiment, a POS (Point of Sales) terminal is described as the sales data processing apparatus. A commodity is described as an example of the sales object. Furthermore, the invention is not limited to the embodiment described later.

FIG. 1 is a plane schematic view illustrating a state in which a POS terminal 1 is arranged inside a store according to the embodiment. A settlement place for settling commodities displayed in the store is arranged inside the store. FIG. 1 is a diagram illustrating one of plural long-shaped counters 4 at the settlement place. A flat plane 5 is formed on the upper surface of the counter 4, and the POS terminal 1 is arranged on the plane 5.

The POS terminal 1 carries out a sales registration operation relating to sales of a commodity being sold in the store. Through the operation of the POS terminal 1 by an operator CH serving as a store clerk, the POS terminal 1 executes a sales registration processing and a settlement processing for a sold commodity. The sales registration processing refers to a processing of optically reading a code symbol such as a barcode attached to a sold commodity to input the commodity code, displaying a commodity name and a price (commodity information) of the commodity which are read out based on the input commodity code and storing the commodity information in a buffer together. The settlement processing refers to a processing of displaying total amount relating to the transaction based on the commodity information stored in the buffer accompanied with the sales registration processing and calculating and displaying change based on the amount deposited by the customer, a processing of instructing a change dispensing machine to issue change, and a processing of issuing a receipt on which commodity information and settlement information (total amount, deposit amount, change amount, etc.) are printed. Furthermore, a processing which combines the sales registration processing and the settlement processing is referred as a transaction processing.

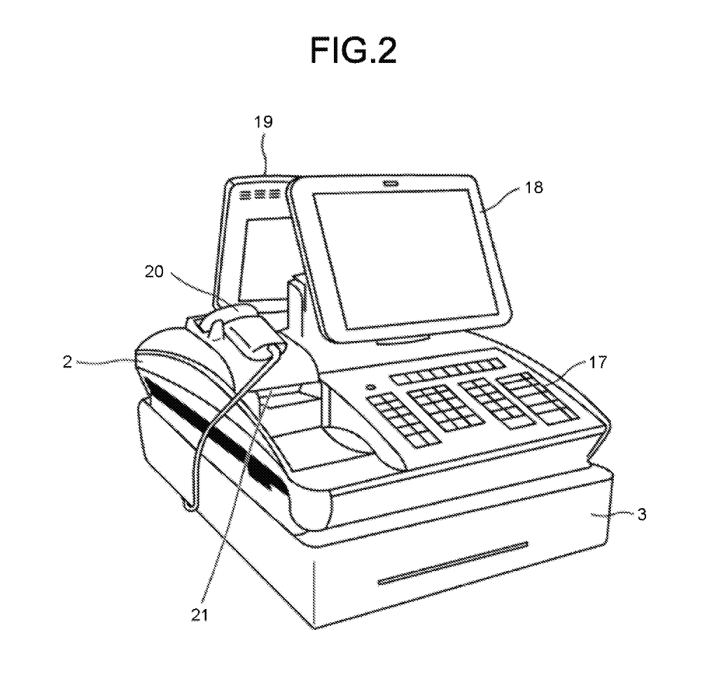

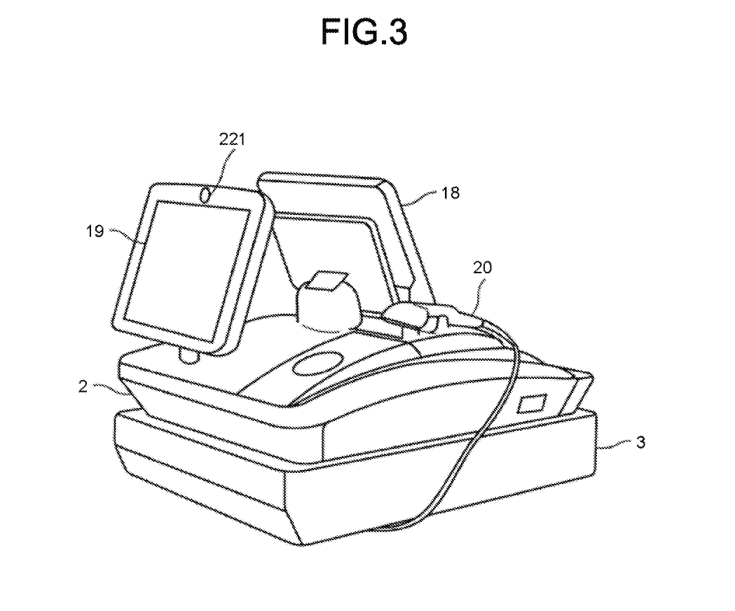

Although the detail of the POS terminal 1 is described with reference to FIG. 2 and FIG. 3, the POS terminal 1 comprises an operation section 17 such as a keyboard operated by the operator CH, a display section for operator 18 for displaying information to the operator CH and a display section for customer 19 for displaying information to a customer C. The operator CH operates the POS terminal 1 at the operator side of the counter 4. The customer C stands at the customer C side of the counter 4.

A camera 191 is arranged on the upper side of outer frame of the display section for customer 19. The camera 191 is constituted by a CCD (Charge Coupled Device) image sensor and the like. The camera 191 which is arranged towards the customer C side is arranged at a position where the customer C who stands in an area surrounded by Cl at the customer C side of the POS terminal 1 can observe a display displayed by the display section for customer 19.

The camera 191 captures motion images or continuous still images (collectively referred to as ‘images’) of the customer C who is executing a transaction. In the embodiment, for example, 10 images of the customer C are captured in one second. The image of the customer C captured by the camera 191 also contains clothes worn by the customer C in addition to the face therein.

FIG. 2 is a perspective view illustrating the appearance of the POS terminal 1 obtained by observing the POS terminal from the operator CH side according to the embodiment. In FIG. 2, the POS terminal 1 includes a main body 2 and a cash box 3. The cash box 3 which includes a drawer houses cash (bills and coins) deposited by the customer C or marketable securities such as a gift voucher and the change to be handed over to the customer C.

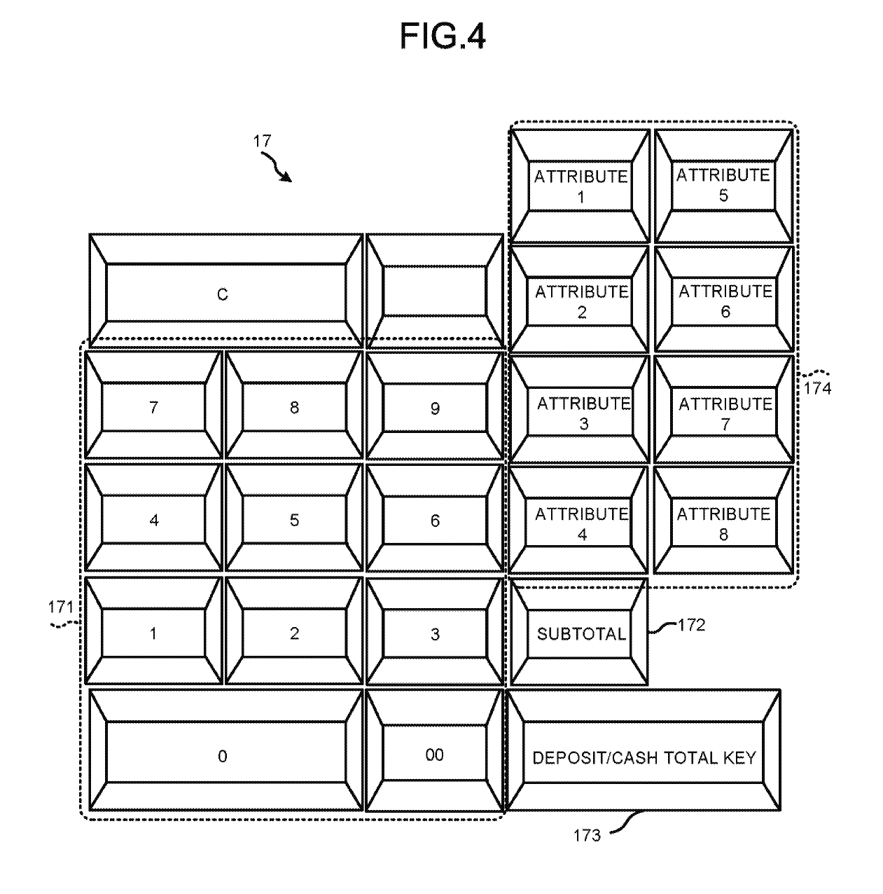

The main body 2 includes the operation section 17, the display section for operator 18, the display section for customer 19 and a reading section 20. The operation section 17 is a keyboard including numeric keys used to input numerals, a subtotal key used to declare the termination of the sales registration processing, and a deposit/cash total key used to declare the termination of the transaction (all refer to FIG. 4). The display section for operator 18, e.g., a liquid crystal display displays information to the operator. The display section for customer 19, e.g., a liquid crystal display displays information to the customer C.

The reading section 20 which includes a CCD line sensor reads a code symbol such as a barcode or a two-dimensional code attached to a commodity and inputs the commodity code for specifying the commodity. In the embodiment, a handy-type reading section 20 is used and the operator CH enables the reading section 20 held in his/her hand to approach or contact the code symbol attached to the commodity to read the code symbol. Furthermore, the reading section 20 may be a scanner that emits light to scan the code symbol with a polygon mirror and receives light reflected from the code symbol.

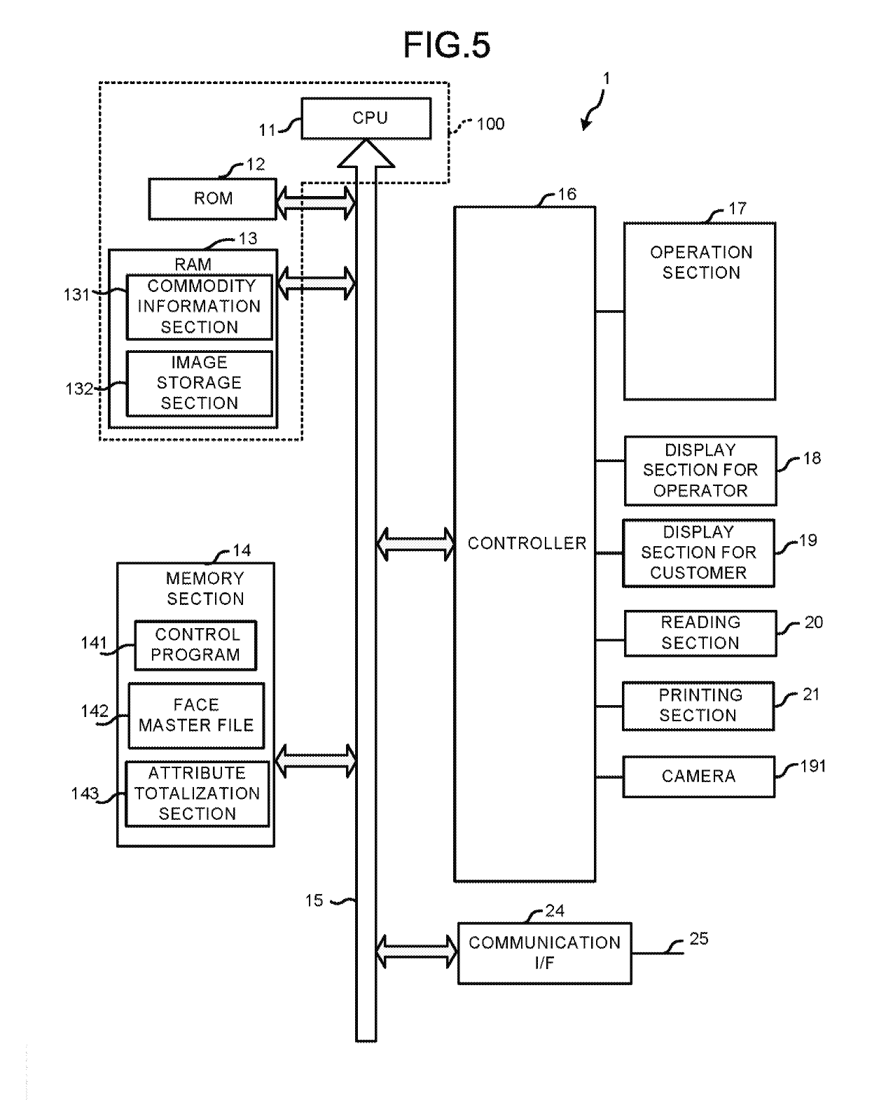

A control section 100 (refer to FIG. 5) and a printing section 21 of the POS terminal 1 are arranged inside the main body 2. The printing section 21 includes, for example, a thermal printer having a thermal transfer type print head. The print section 21 takes out a rolled receipt paper housed in the main body 2, and prints the commodity information and the settlement information on the receipt paper to issue the printed paper as a receipt.

FIG. 3 is a perspective view illustrating the appearance of the POS terminal 1 obtained by observing the POS terminal from the customer C side according to the embodiment. In FIG. 3, the POS terminal 1 is equipped with the camera 191 constituted by the CCD image sensor at the top of display surface side of the display section for customer 19.

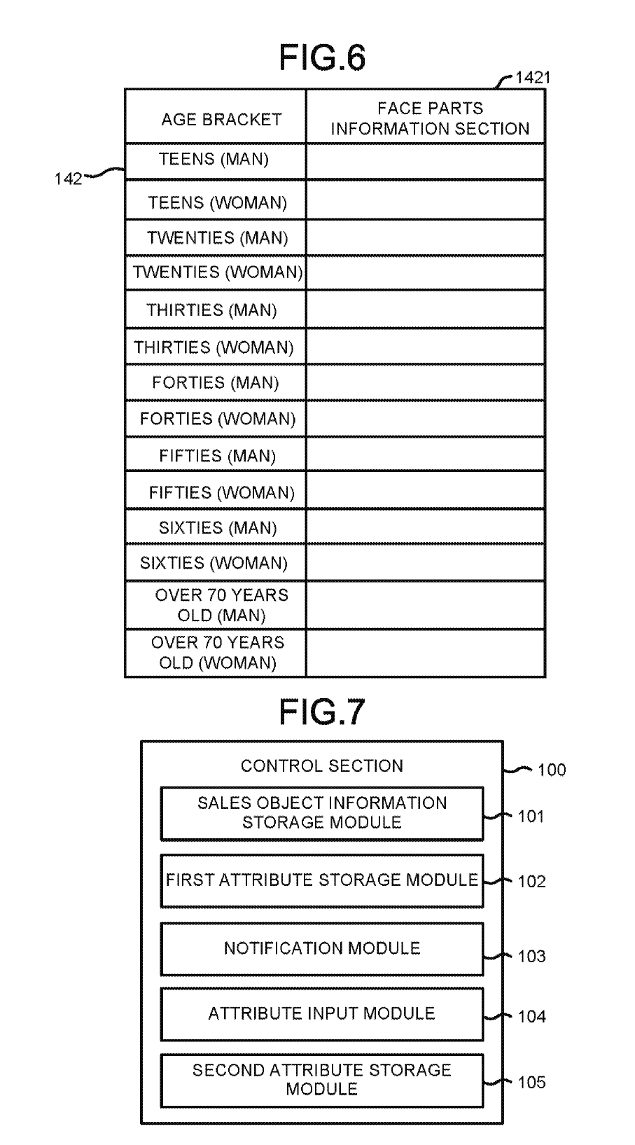

FIG. 4 is a plane view illustrating a part of the operation section 17 of the POS terminal. In FIG. 4, the operation section 17 includes numeric keys 171, a subtotal key 172, a deposit/cash total key 173 and a clientele key 174 serving as an attribute key. The numeric keys 171 include numerals from 0 to 9 and are used to input, for example, the quantity of commodities. The subtotal key 172 is used to declare the termination of the sales registration processing and the start of the settlement processing of the commodity. The deposit/cash total key 173 is used to declare the termination of the transaction with the customer. The clientele key 174 is used to input attributes (gender or age bracket) of the customer. In FIG. 4, the operation section 17 includes 8 clientele keys for convenience; however, actually, the operation section 17 includes 14 clientele keys corresponding to clienteles shown in FIG. 6. The clientele keys 174 correspond to different attributes respectively, and the attribute corresponding to the operated clientele key 174 is output. For example, if the clientele key 174 corresponding to an attribute 1 is operated, an attribute of gender (male) and age bracket (teens) is output.

Next, with the use of FIG. 5 and FIG. 6, the hardware structure of the POS terminal 1 is described. FIG. 5 is a block diagram illustrating the hardware structure of the POS terminal 1. In FIG. 5, the POS terminal 1 includes a CPU (Central Processing Unit) 11, a ROM (Read Only Memory) 12, a RAM (Random Access Memory) 13 and a memory section 14. The CPU 11 is a main part of control. The ROM 12 stores various programs. The RAM 13 copies or decompresses programs and various data. The memory section 14 stores various programs. The CPU 11, the ROM 12, the RAM 13 and the memory section 14 are connected with each other through a data bus line 15. The CPU 11, the ROM 12 and the RAM 13 constitute the control section 100. In other words, the control section 100 executes a control processing described later through the operation of the CPU 11 according to a control program 141 which is stored in the ROM 12 or the memory section 14 and copied or decompressed in the RAM 13.

The RAM 13 includes a commodity information section 131 and an image storage section 132. The commodity information section 131 stores commodity information (commodity name, price of commodity, etc.) of a commodity to which the sales registration processing is carried out corresponding to the commodity code read by the reading section 20. The image storage section 132 stores a face image of the customer C whose face is detected according to an image captured by the camera 191. A face detection technology for detecting a face is a well-known technology which detects all parts (eyes, nose, mouth, ears, chin, etc.) on a face described later according to an image captured by the camera 191 to detect that the face is a face of a person.

The memory section 14 is constituted by a non-volatile memory such as an HDD (Hard Disc Drive) or a flash memory in which storage information is held even if the power source is cur off and stores programs including a control program 141. Furthermore, the memory section 14 includes a face master file 142 (refer to FIG. 6) and an attribute totalizing section 143.

The attribute totalizing section 143 associates the commodity information of the commodity (that is, the commodity purchased by the customer) to which the sales registration processing is executed by the POS terminal 1 with attribute information of the customer who purchases the commodity and totalizes and stores them by attributes (by gender and age bracket). The tendency or trend of purchasing commodities by attributes can be analyzed based on the commodity information stored in the attribute totalizing section 143.

Furthermore, the data bus line 15 is connected with the operation section 17, the display section for operator 18, the display section for customer 19, the reading section 20, the printing section 21 and the camera 191 through a controller 16. The controller 16 receives an instruction from the control section 100 and controls the operation section 17, the display section for operator 18, the display section for customer 19, the reading section 20, the printing section 21 and the camera 191. However, a control executed by the controller 16 is described as a control executed by the control section 100 for convenience of description.

Further, the data bus line 15 is connected with a communication I/F (Interface) 24. The communication I/F 24 is electrically connected with other POS terminals 1 arranged inside the store or a store server (not shown) through a communication line 25. The store server is electrically connected with all the POS terminals 1 arranged in the store and collects the commodity information and the settlement information from each POS terminal 1. The store server sends the commodity information and the settlement information collected from the POS terminal 1 to a headquarters server (not shown) arranged in the headquarters.

FIG. 6 is memory map illustrating the face master file 142 of the memory section 14. In FIG. 6, the face master file 142 includes face parts information sections 1421 for storing face parts information serving as face information associated with each gender—each age bracket from teens to more than seventy years old. Each face parts information section 1421 stores face parts information that can specify the attributes (age bracket or gender) respectively.

The face parts information refers to data which indicates each part and feature of each attribute and is classified matching with parts and features of individual face and data indicating, for example, features of parts (eyes, nose, mouth, ears and chin of an individual) and deformation features such as a smiling face, a serious face, a face with closing eyes or a face with opening eyes. The face parts information stored by each attribute indicates features of the attribute different from other attributes. For example, information of eyes, nose, mouth and ears indicating features of males in their teens and information of a smiling face and a serious face indicating features of males in their teens are stored in the face parts information section 1421 of teens (male). The face parts information by this attribute is created based on a large amount of statistics data and obviously indicates the attributes thereof.

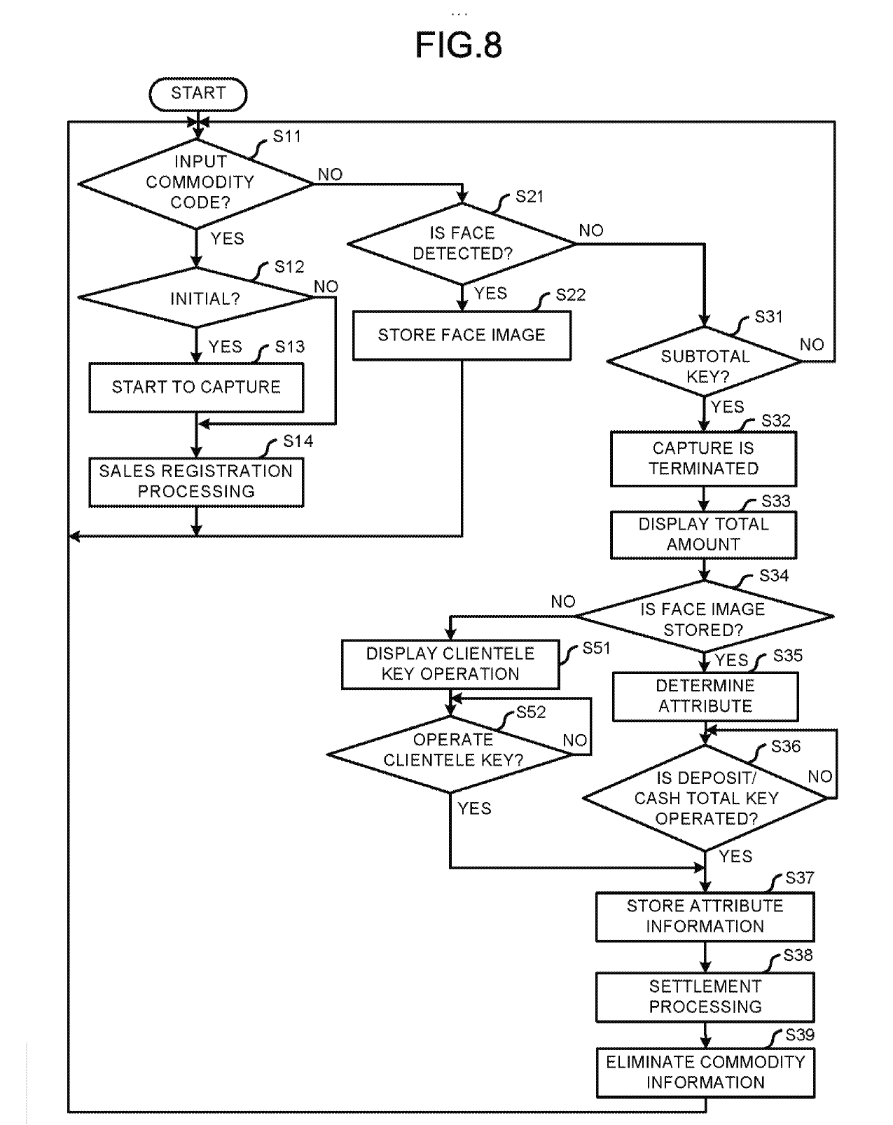

Next, with the use of FIG. 7 and FIG. 8, the control processing of the POS terminal 1 is described. FIG. 7 is a functional block diagram illustrating functional components of the POS terminal 1. The control section 100 functions as a sales object information storage module 101, a first attribute storage module 102, a notification module 103, an attribute input module 104 and a second attribute storage module 105 according to various programs containing the control program 141 stored in the ROM 12 or the memory section 14.

The sales object information storage module 101 has a function of storing the commodity information of the commodity to which the transaction processing is executed in the storage section.

The first attribute storage module 102 has a function of associating, in a case in which a face through which the attributes of the customer who purchases the commodity can be determined can be detected based on the image captured by the camera, the attribute information indicating attributes determined based on face image information of the detected face with the commodity information and storing them in the storage section.

The notification module 103 has a function of notifying the operator of a message for urging the operator to input the attribute information indicating attributes of the customer through an operation of the operator in a case in which the face through which attributes of the customer who purchases the commodity can be determined cannot be detected based on the captured image.

The attribute input module 104 has a function of inputting the attribute information indicating attributes of the customer through an operation of the operator.

The second attribute storage module 105 has a function of associating the attribute information input by the attribute input module 104 with the commodity information and storing them in the storage section.

FIG. 8 is a flowchart illustrating procedures of a control processing of the POS terminal 1. In FIG. 8, the control section 100 determines whether or not a code symbol attached to the commodity is read by the reading section 20 and the commodity code is input (Act S11). In a case in which it is determined that the commodity code is read (Yes in Act S11), the control section 100 determines whether or not the commodity code input in S11 is the initial commodity code of the commodity in the transaction (S12). The control section 100 determines that the commodity code is initially input in the transaction in a case in which the commodity information of the commodity is not stored in the commodity information section 131.

In a case in which it is determined that the commodity code is initially input in the transaction (Yes in S12), the control section 100 starts the camera 191 to start to photograph the customer C with the camera 191 as the start of the sales registration processing of the commodity (S13). Then, the control section 100 (sales object information storage module 101) executes the sales registration processing based on the input commodity code and stores the commodity information in the commodity information section 131 (S14). Then, the control section 100 returns to the processing in S11.

On the other hand, in a case in which it is determined that the commodity code is not input (No in S11), the control section 100 determines whether or not a face is detected according to the image captured by the camera 191 with the use of the foregoing face detection technology (S21). In a case in which the face is detected (Yes in S21), the control section 100 stores the face image of the detected face in the image storage section 132 (S22). Then, the control section 100 returns to the processing in S11.

Further, in a case in which it is determined that the face is not detected according to the image captured by the camera 191 (No in S21), the control section 100 determines whether or not the subtotal key 172 is operated (S31). In a case in which it is determined that the subtotal key 172 is operated (Yes in S31), the control section 100 terminates the photography of the customer C by the camera 191 as the termination of the sales registration processing of the commodity (S32). Then, the control section 100 displays the total amount in the transaction based on the commodity information stored in the commodity information section 131 (S33).

Next, the control section 100 determines whether or not the face image of the customer C whose face is detected is stored in the image storage section 132 (S34). In a case in which it is determined that the face image is stored (Yes in S34), the control section 100 determines the attributes of the customer C based on the stored face image (S35). In other words, the control section 100 collates face parts information contained in the face image of the customer C stored in the image storage section 132 with each face parts information stored in the face parts information section 1421. Then, the control section 100 extracts the attribute information of the attributes corresponding to the face parts information matching with that stored in the face parts information section 1421 to determine the attributes of the customer C.

Next, the control section 100 determines whether or not the deposit/cash total key 173 serving as a termination key for declaring the termination of the transaction is operated by the operator CH (S36). The control section 100 waits for until the deposit/cash total key 173 is operated (No in S36); on the other hand, in a case in which it is determined that the deposit/cash total key 173 is operated (Yes in S36), the control section 100 executes the processing in S37˜S39 for the termination of the transaction.

In other words, the control section 100 (the first attribute storage module 102) associates the commodity information stored in the commodity information section 131 with the attribute information indicating the attributes determined in S35 and stores them in the attribute totalizing section 143 (S37). The stored attributes are accumulated and applied to the clientele analysis and the sales analysis of the commodity. Next, the control section 100 executes the settlement processing based on the commodity information stored in the commodity information section 131 (S38). If the settlement processing is terminated, the control section 100 eliminates the commodity information stored in the commodity information section 131 (S39). Then, the control section 100 returns to the processing in S11.

On the other hand, in S34, in a case in which it is determined that the face image of the customer C is not stored (that is, the face is not detected) (No in S34), the control section 100 (notification module 103) displays a message indicating an operation on the clientele key 174 on the display section for operator 18 to notify the operator CH of the demand on inputting the attribute information (S51)

The message for the operator CH is used to urge the operator CH to determine the attributes of the customer C and operate clientele key 174 to input the attribute information as the POS terminal 1 cannot determine the attributes. The operator CH who sees the message determines the attributes of the customer C and operates the clientele key 174 that seems to correspond to the attributes. Thus, the clientele information corresponding to the operated clientele key 174 is input.

The control section 100 (attribute input module 104) determines whether or not any one of the clientele keys 174 is operated which serves as a termination key for declaring the termination of the transaction (S52). The control section 100 waits for until any one of the clientele keys 174 is operated (No in S52), and executes the processing in S37˜S39 in a case in which it is determined that any one of the clientele keys 174 is operated (Yes in S52), as the operation of the clientele key 174 means the declaration of the termination of the transaction. In S37, the control section 100 (second attribute storage module 105) associates the commodity information stored in the commodity information section 131 with the attribute information indicating the attributes input in S51 and stores them in the attribute totalizing section 143. Furthermore, in S31, in a case in which it is determined that the subtotal key 172 is not operated (No in S31), the control section 100 returns to the processing in S11.

According to such an embodiment, the control section 100 determines the attributes of the customer C based on a face image in a case in which the face image of the customer can be captured, or displays a message to urge the operator CH to operate the clientele key 174 to input the attribute information in a case in which the face image of the customer C cannot be captured. Thus, even if the POS terminal 1 cannot determine the attributes of the customer C, as the attribute information of the customer C is input, it is possible that the attribute information of the customer C is input more accurately.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment, the control section 100 terminates the capture of the image at the time the subtotal key 172 is operated; however, it is not limited to this. For example, the control section 100 may terminate the capture of the image when it is determined that the face image is stored in the image storage section 132 (S34)

Further, in the embodiment, it is described that the continuous still images are captured by the camera 191; however, it is not limited to this, the motion image may be captured.

In the embodiment, in a case in which the transaction is terminated, the deposit/cash total key 173 for settling with cash is operated; however, a closing key of other category may be operated.

In the embodiment, a message indicating that the clientele key 174 is operated is displayed in the display section for operator 18 to notify the operator CH that an input of the attribute information is demanded; however, it is not limited to this. Other means (for example, sound) may be used to notify the operator CH.

In the embodiment, the commodity is described as an example of the sales object; however, it is not limited to this. The sales object (for example, service) other than the commodity may be used.

Furthermore, the programs executed by the sales data processing apparatus of the embodiment may be recorded in a computer-readable recording medium such as a CD-ROM, an FD (Flexible Disk), a CD-R or a DVD (Digital Versatile Disk) in the form of installable or executable file to be provided.

The programs executed by the sales data processing apparatus of the embodiment may be stored in a computer connected with a network such as an internet and be supplied by being downloaded through the network. Further, the programs executed by the sales data processing apparatus of the embodiment may be supplied or distributed through a network such as an internet.

The programs executed by the sales data processing apparatus of the embodiment may be supplied in a manner of being incorporated into the ROM.

What is claimed is:

1. A sales data processing apparatus, comprising:
a sales object information storage module configured to store sales object information of a sales object to which a transaction processing is carried out in a storage section;
a first attribute storage module configured to associate attribute information indicating attributes determined based on face image information of a detected face with the sales object information and store them in the storage section in a case in which the face through with attributes of a customer who purchases the sales object can be determined can be detected based on an image captured by a camera;
a notification module configured to notify an operator of a message for urging the operator to input the attribute information indicating attributes of the customer through an operation of the operator in a case in which the face through which attributes of the customer who purchases the sales object can be determined cannot be detected based on the captured image;
an attribute input module configured to input the attribute information indicating attributes of the customer through an operation of the operator; and
a second attribute storage module configured to associate attribute information input by the attribute input module with the sales object information and store them in the storage section.

2. The sales data processing apparatus, according to claim 1, wherein
the first attribute storage module stores attributes of the customer determined based on the face detected according to the image captured from start to end of a sales registration processing of the sales object contained in the transaction processing.

3. The sales data processing apparatus according to claim 1, further comprising
a display section for operator configured to display information to the operator, wherein
the notification module displays a message to urge the operator to input attribute information of the customer on the display section for operator.

4. The sales data processing apparatus according to claim 2, further comprising
a display section for operator configured to display information to the operator, wherein
the notification module displays a message, to urge the operator to input attribute information of the customer on the display section for operator.

5. The sales data processing apparatus according to claim 1, further comprising
a termination key configured to declare termination of a transaction with the customer, wherein
the first attribute storage module and the second attribute storage module associate the attribute information with sales object information of the sales object which is transacted in a case in which the termination key is operated.

6. The sales data processing apparatus according to claim 1, wherein
the attribute input module refers to a plurality of clientele keys respectively used to specify gender or age bracket of the customer.

7. A method for controlling a sales data processing apparatus to input attribute information of a customer, including:
storing sales object information of a sales object to which a transaction processing is carried out in a storage section;
associating attribute information indicating attributes determined based on face image information of a detected face with the sales object information and storing them in the storage section in a case in which the face through which attributes of a customer who purchases the sales object can be determined can be detected based on an image captured by a camera;
notifying an operator of a message for urging the operator to input the attribute information indicating attributes of the customer through an operation of the operator in a case in which the face through which attributes of the customer who purchases the sales object can be determined cannot be detected based on the captured image;
inputting the attribute information indicating attributes of the customer through an operation of the operator; and
associating input attribute information with the sales object information and storing them in the storage section.
